(19) United States
(12) Patent Application Publication
(10) Pub. No.: US 2015/0147451 A1
(43) Pub. Date: May 28, 2015

(54) Novel Food and Feed Antioxidants and Preservatives Based on Antioxidant Enzymes Extracted From Animal Blood

(71) Applicant: Clemson University, Anderson, SC (US)

(72) Inventors: Vladimir Reukov, Central, SC (US); Alexey Vertegel, Easley, SC (US)

(21) Appl. No.: 14/412,704

(22) PCT Filed: Jul. 16, 2013
(86) PCT No.: PCT/US2013/050598

§ 371 Date: Jan. 5, 2015

Related U.S. Application Data
(60) Provisional application No. 61/671,817, filed on Jul. 16, 2012.

(51) Int. Cl. A23L 3/3472; A23K 3/00

(52) U.S. Cl. CPC A23L 3/3472; A23K 3/00; A23V 2002/00
USPC 426/542; 435/189; 435/192; 562/556

(57) ABSTRACT

Disclosed is a process for extracting an antioxidant cocktail (containing a number of antioxidative molecules including but not limited to superoxide dismutase (SOD), catalase, glutathione, glutathione peroxidase) from animal sources (i.e., blood or liver) so that it can be used as a food and feed preservative in a non-purified state to prevent rancidity. The antioxidant can also be used in other products such as oils, paint, caulking, plastics, or any other product exposed to oxidation. The disclosed antioxidant cocktail can be used in an unpurified state, yet can still function as a potent antioxidant without having to undergo purification via complex, expensive methods such as chromatography or gel filtration.

### CROSS REFERENCE TO RELATED APPLICATIONS

This application claims filing benefit of previously filed U.S. Provisional Application Ser. No. 61/671,817 having a filing date of Jul. 16, 2012, incorporated herein by reference in its entirety.

### BACKGROUND OF THE INVENTION

Antioxidants are vital components of food industry, which has a major affect on global health and wellness. Antioxidants prevent rancidity caused by oxidation of lipids. Other industries also utilize antioxidants, including, but not limited to, those producing dyes, paints, and other oil-based materials. Most of the antioxidants currently being used are synthetic chemicals, and there is a global concern among regulatory bodies and customers regarding the safety of these compounds. There is a major shift towards naturally-derived antioxidants in response to these and other health concerns related to synthetic antioxidants. However, natural antioxidants currently available in the market are much more expensive, and are often not as effective as their synthetic counterparts. Thus, there is a need for inexpensive and capable natural antioxidants.

Many food products including human food, pet food, and animal feeds, contain fats and oils from rendered materials. Rendering is the process of converting inedible animal tissues such as tendons, bones, and organs into stable value-added materials. The majority of the material processed comes from slaughterhouses but can also come from restaurant grease, butcher shops, or grocery stores. The most common sources of rendered material are swine, cattle, poultry, turkey, sheep and fish. Rendering includes a process of separating the starting material into two separate streams of rendered materials —(1) high fat materials and (2) low fat materials that contain bone, ash, and protein. Thus, two separate yields can be obtained after the completion of the rendering process—a high fat commodity and a low fat commodity, such as protein meal. Rendered material can be used in over 3,000 industrial applications. For instance, the high fat component can be sold as lard or tallow or used as a source of biofuel. Additionally, the high fat component can be used in soaps, lubricants, detergents, cosmetics, other personal care products, or up-graded animal feed. Meanwhile, the low fat component, such as protein meal, can also be used as animal feed. There are over 250 rendering facilities in North America producing over 20 billion pounds of rendered material per year. About 50% of the total amount of the rendered material constitutes fats and oils.

Rendered fats and oils are important components in animal feeds. However, the rendered fats and oils can be degraded by lipid auto-oxidation processes that can decrease the nutritive value of animal feeds made with the rendered fats and oils. In addition, oxidation can affect the flavor, color, odor, and texture of feeds, which can affect palatability. For example, certain fatty acids such as linoleic acid and linolenic acid contain unsaturated carbon-carbon bonds that can be unstable and very susceptible to lipid auto-oxidation.

While antioxidants have been added as feed preservatives to prevent degradation of the fats and lipids contained in animal feed components sourced from rendered materials, many of these antioxidants, such as ethoxyquin, mixed tocopherols (vitamin E), vitamin C, and butylated hydroxyanisole/butylated hydroxytoluene, are expensive and must be obtained from a source outside the rendering industry. In addition, the FDA and other regulatory agencies, as well as consumers, have expressed concern about the safety of synthetic antioxidants such as ethoxyquin. As such, the rendering industry seeks natural solutions to extend the shelf life of its products in an affordable manner while maintaining product freshness and quality. Thus, what is needed in the art is a potent antioxidant that can be used as a feed preservative that is sourced from within the rendering industry, such as from animal byproducts, in a cost-effective manner and that can be easily and efficiently obtained. More broadly, there is a need and customer demand for a potent and inexpensive natural antioxidant that can be used in various types of foods, including human food, pet food and animal feeds. What is also needed is a method for extracting antioxidants from animal byproducts without the use of organic solvents, which can be costly and raise safety concerns.

### SUMMARY OF THE INVENTION

Generally speaking, the present disclosure is directed to a method of extracting antioxidants from a natural source (i.e., animal blood, such as avian, bovine, or porcine blood), then utilizing the extracted antioxidants as a food or feed preservative. However, it is to be understood that the extracted antioxidants can also be utilized in other applications where oxidation is a concern. For instance, the antioxidants can be used in the production of oils, dyes, paints, coatings, greases, lubricants, or any other oil or fat-based materials. The antioxidants can also be used as a drug or bio-active food supplement.

In one embodiment, the present disclosure is directed to an antioxidant for preserving a food product, wherein the antioxidant is extracted from animal blood. The antioxidant can comprise superoxide dismutase (SOD), catalase, glutathione, glutathione reductase, glutathione peroxidase, or any other antioxidant naturally present in the animal blood, or a combination thereof. Further, the antioxidant can be generally free from hemoglobin. It should be understood that the antioxidant does not have to be completely purified and can contain other blood components and other compounds added during the processing of the blood to achieve partial purification, such as compounds added to remove hemoglobin or to increase the antioxidant concentration.

In another embodiment, the present disclosure is directed to a method of extracting an antioxidant from animal blood. The method includes obtaining a sample of animal blood, wherein the animal blood contains erythrocytes; lysing the erythrocytes to form a solution containing the antioxidant; and treating the solution to remove hemoglobin from the solution, such as by treating the solution with at least one compound or by removing the hemoglobin via physical means, such as by ultrafiltration or electrophoresis. The compound can be an inorganic compound, such as, for example, a metal salt. In some embodiments, the inorganic compound is a zinc salt or other zinc-containing compound. The inorganic compound can be added at a concentration ranging from about 0.1% w/v to about 20% w/v based on the volume of the solution.

In another embodiment, the compound can be tert-butanol (2-methyl-2-propanol). The tert-butanol (2-methyl-2-propanol) can be added at a concentration ranging from about 1% w/v to about 50% w/v based on the volume of the solution. In another embodiment, the solution can be treated with a first compound that is ethanol and a second compound that is 1-butanol, 2-butanol, or isobutanol (2-methyl-1-propanol). The first compound can be added at a concentration ranging from about 5% w/v to about 50% w/v and the second compound can be added at a concentration ranging from about 0.5% w/v to about 30% w/v based on the volume of the solution.

In still another embodiment, the present disclosure is directed to a method of treating a food product with an antioxidant. The method includes extracting an antioxidant from erythrocytes in animal blood and applying the antioxidant to the food product. Extracting the antioxidant from animal blood can include obtaining a sample of animal blood, wherein the animal blood contains erythrocytes; lysing the erythrocytes to form a solution containing the antioxidant; and treating the solution to remove hemoglobin from the solution to remove hemoglobin from the solution, such as by treating the solution with at least one compound or by removing the hemoglobin via physical means, such as ultrafiltration or electrophoresis. In some embodiments, the compound can be an inorganic compound. The inorganic compound can be a metal salt, such as, for example, a zinc salt, or another zinc-containing compound. The inorganic compound can be added at a concentration ranging from 0.1% w/v to about 20% w/v based on the volume of the solution. In some embodiments, the antioxidant can be in the form of a solution applied at a concentration ranging from about 0.1 microliters per gram of food product to about 100 microliters per gram of food product. The antioxidant can be in an unpurified state, and the food product can be pet food, animal feed, or food for human consumption.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates one embodiment of a method of extracting an antioxidant (i.e., non-purified superoxide dismutase (SOD)) sourced from an animal byproduct (i.e., blood) as disclosed herein.

FIG. 2 shows the non-purified chicken blood SOD activity of various samples after 20 weeks at 25° C., compared to a control at 4° C.

FIG. 3 shows the non-purified chicken blood SOD activity of various samples after 40 weeks at 25° C., compared to a control at 4° C.

FIG. 4 is a graph comparing the antioxidant activity of non-purified SOD extracted from animal byproducts compared with that of currently used feed preservative antioxidants via a colorimetric thiobarbituric acid reactive substances (TBARS) assay.

FIG. 5 illustrates another method of extracting unpurified natural antioxidants (“crude protein” or CP) from an animal source (i.e., blood).

FIG. 6 is a graph comparing the ability of the natural antioxidants in the crude protein of the present disclosure with the ability of currently used feed preservative antioxidants to prevent oxidation in ground chicken patties. Ferrous oxidation—Xylenol Orange (FOX) assay have been used to assess degree of oxidation in chicken patties. “Crude protein” or CP here and below refers to an unpurified mixture of natural antioxidants, present along with other biomolecules and substances, obtained by the general method illustrated in FIG. 5.

FIG. 7 is a graph comparing the ability of the natural antioxidants in the “crude protein” of the present disclosure with the ability of currently used feed preservative antioxidants to prevent oxidation in chicken fat using FOX assay.

FIG. 8 is a graph comparing the ability of the natural antioxidants in the “crude protein” of the present disclosure added at different concentrations with the ability of currently used feed preservative antioxidants to prevent oxidation in ground chicken patties using FOX assay. As low as 17 micrograms of CP per gram food, or approximately 17 liter of CP per ton food were found to be as efficient as 1000 ppm PET-OX™ (based on the fat content), a concentration currently used in industry.

FIG. 9 is a graph showing the ability of the natural antioxidants in the “crude protein” of the present disclosure to remain effective after accelerated aging at 50° C. for up to 10 days in a ground chicken meat model. This corresponds to approximately 3 months shelf life at room temperature.

FIG. 10 is another graph showing the ability of the natural antioxidants in the “crude protein” of the present disclosure to remain effective after accelerated aging at 50° C. in a chicken fat model.

FIG. 11 is a graph comparing the antioxidant activity of a crude protein solution, SOD concentrate, 1000 U/mL catalase, PET-OX™, and water (no antioxidant activity) when applied to beef patties using a fluorometric TBARS assay.

FIG. 12 is a graph comparing the antioxidant activity of a crude protein solution, SOD concentrate obtained using the method shown in FIG. 1, 1000 U/mL SOD, 1000 U/mL catalase, PET-OX™, and water (no antioxidant) when applied to chicken fat using a FOX assay.

### DETAILED DESCRIPTION OF PREFERRED EMBODIMENTS

Reference will now be made in detail to various embodiments of the disclosed subject matter, one or more examples of which are set forth below. Each embodiment is provided by way of explanation of the subject matter, not limitation of the subject matter. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment. Thus, it is intended that the present disclosure cover such modifications and variations as come within the scope of the appended claims and their equivalents.

In general, disclosed herein is an antioxidant that can be used as a food preservative. A single antioxidant can be extracted from a natural source, such as animal blood, or multiple antioxidants can be extracted from the natural source, depending on which of the methods discussed below are utilized. In particular, the antioxidants can be derived from erythrocytes (red blood cells) in blood, as RBCS are natural oxygen carriers and are equipped with a highly efficient antioxidant system that includes a number of antioxidant enzymes and compounds. These antioxidants may include glutathione, enzymes superoxide dismutase, catalase, glutathione oxidase, and other biomolecules and compounds, some of which may yet be unknown. These antioxidants can be isolated from blood in purified form but in many circumstances can be used in partially purified form, in a mixture with other blood components. In many cases, use of partially purified antioxidant mixtures may be beneficial because of lower processing costs. After the antioxidants are extracted, such as in the form of partially purified “crude protein”, the antioxidants can then be added to animal feed, pet food, food for human consumption, oils, dyes, paints, or any other product where oxidation is a concern.

For instance, in one embodiment, the antioxidant to be extracted is superoxide dismutase (SOD) that can be sourced from within the rendering industry, such as from animal byproducts. The non-purified antioxidant of the present disclosure can be extracted from animal byproducts such as blood and can be used as a food preservative. SOD is an enzyme that functions as a free-radical scavenger. At the cellular level, SOD out-competes damaging oxidation reactions, thus protecting cells from oxidation toxicity. SOD can catalyze the dismutation of superoxide into less toxic oxygen and hydrogen peroxide. The SOD-catalysed dismutation of superoxide may be written with the following half-reactions:

M⁽ⁿ⁺¹⁾−SOD+O₂⁻→Mⁿ⁺-SOD+O₂

Mⁿ⁺−SOD+O₂⁻+2H⁺→M⁽ⁿ⁺¹⁾⁺−-SOD+H₂O₂

where M=Cu (n=1); Mn (n=2); Fe (n=2); Ni (n=2). In this reaction the oxidation state of the metal cation oscillates between n and n+1. The oxidation reaction occurs quite rapidly in the cell to protect sensitive and critical cellular targets, such as lipids in the cell membrane.

Beneficially, SOD can be extracted from animal tissue, such as blood at relatively little cost. According to the present disclosure, SOD is extracted and stored in the form of a non-purified enzyme concentrate so that it maintains at least 50% or more of its initial antioxidant activity. Moreover, such unpurified enzyme concentrate also exhibits catalase activity—another enzyme effective against hydrogen peroxide, which can act synergistically with SOD, and reduce peroxide, formed from superoxide. The SOD enzyme concentrate can then be utilized as an antioxidant, for instance in animal feed.

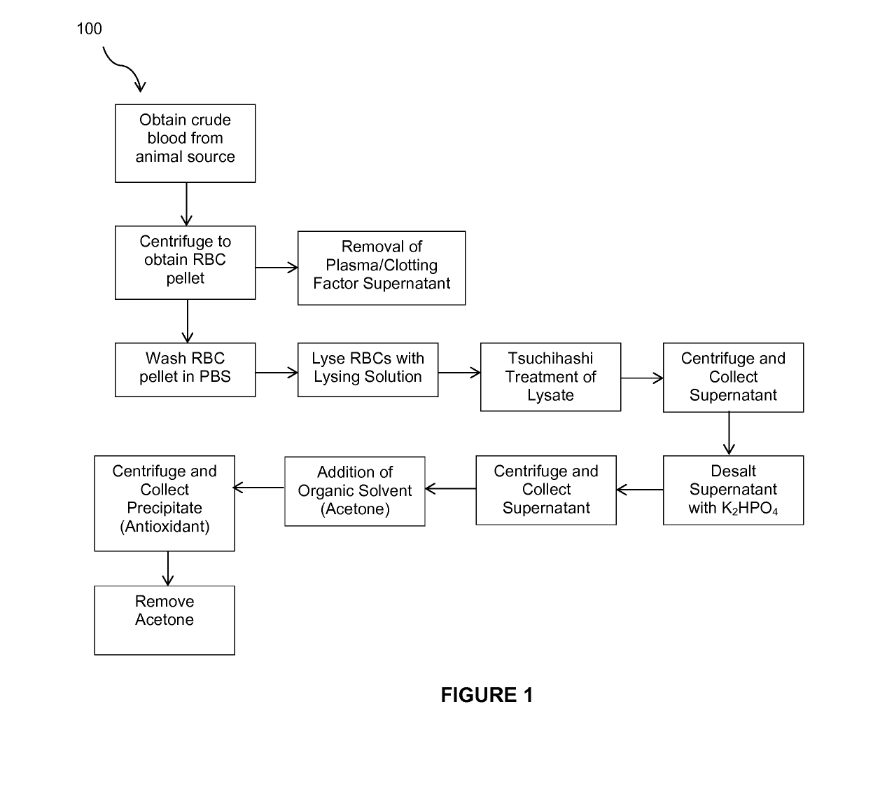

A general overview of the extraction process is shown in the flow diagram of FIG. 1. In the method 100 of FIG. 1, first, the crude animal tissue can be obtained from any source, such as from a slaughterhouse/poultry plant. In general, the crude animal tissue can be blood, as blood is readily processable according to an extraction process, but the extraction process is not limited to utilization of blood as the source material, and in other embodiments, alternative tissues (e.g. liver, spleen etc.) may be utilized, optionally in conjunction with an amount of blood. Any tissue source can be utilized including, without limitation, cattle, swine, poultry, sheep, chickens, or any other suitable animal source.

The tissue source can be processed to concentrate those components of the tissue that contain SOD. For example, in those embodiments in which crude blood is utilized, the crude blood can be processed to obtain a material having a high concentration of red blood cells. By way of example, the crude blood can be centrifuged, for instance at a rate of from about 250 g (relative centrifugal force) to about 750 g, such as at a rate of about 500 g, in order to separate the blood and obtain a product having a high concentration of red blood cells (RBCS) as a pellet. The supernatant (i.e., plasma and other clotting factors) can be discarded or used for other purposes. The high SOD containing pellet can be further processed to extract the SOD. For example, the red blood cells can be washed in lx Phosphate Buffered Saline (PBS) to remove any remaining plasma and/or clotting factors. Next, the pellet of RBCS can be lysed in a lysing solution, using a volume of solution that is twice the volume of the RBC pellet. The lysing solution can generally include 0.15 M ammonium chloride (NH₄Cl), 10 mM potassium bicarbonate (KHCO₃), 0.1 mM ethylenediaminetetraacetic acid (EDTA), and 1% polyoxyethylene octyl phenyl ether (Triton X-100) in distilled water. Treating the RBC pellet in the lysing solution lyses the red blood cells and releases the SOD enzyme in conjunction with other components of the cells. The lysis can be carried at for about 20-30 minutes, such as about 25 minutes, under vigorous shaking. The lysis solution can include cold (4° C.) deionized water with or without addition of surfactants such as TritonX or other suitable surfactants.

The SOD-containing hemolysate can then be separated from other components of the mixture. For instance, other proteins can be denatured by subjecting the hemolysate to a Tsuchihashi treatment where the hemolysate supernatant is mixed with ethanol (about 0.25 volume of the supernatant) and chloroform (about 0.15 volume of the supernatant). During the treatment, the hemolysate is stirred vigorously for about 25 minutes, resulting in a brick-red solution. The solution can then be centrifuged at a rate of from about 3000 g to about 5000 g, such as at a rate of about 4000 g, for about 10-20 minutes, such as for about 15 minutes, in order to separate the denatured proteins and hemoglobin from the other lysed red blood cell contents in the chloroform phase. The relatively clear supernatant (ethanol phase) can be collected. Next, about 300 grams/liter of potassium phosphate (K₂HPO₄) can be added to the supernatant to move the SOD enzyme from the organic phase to the water phase, wherein it can be reactivated in an ionic environment. This solution can be centrifuged at a rate of from about 4000 g to about 6000 g, such as at a rate of about 5000 g, to precipitate additional extraneous proteins and remove left over chloroform. The pale yellow supernatant containing the SOD can then be collected.

Next, acetone (stored at 31 20° C.) or another organic solvent can be added to the supernatant at a volume ratio of 2:1, and the resulting solution can be centrifuged at a rate of from about 4000 g to about 6000 g, such as about 5000 g, for about 10-20 minutes, such as about 15 minutes, to ensure precipitation of the desired protein of interest. At this point, the SOD can precipitate out of the acetone or other solvent solution, resulting in a cream-colored precipitate. The acetone can then be recovered, leaving the SOD enzyme, which is non-purified, meaning it has not undergone purification via chromatography or gel filtration after precipitation out of solution. Next, the non-purified SOD enzyme can be washed twice in 1× Dulbecco's PBS, centrifuged at a rate of from about 4000 g to about 6000 g, such as at a rate of about 5000 g, and stored in a solution that can include a stabilizer and/or a cryoprotectant such as, without limitation, trehalose, sucrose, dextrose, mannitol, glycerol, etc., or the SOD can be lyophilized for future use. The SOD activity can be measured in Units/milliliter of initial blood volume (U/mL of initial blood volume) via a WST SOD activity assay (water-soluble tetrazolium salt, (2-(4-Iodophenyl)- 3-(4-nitrophenyl)-5-(2,4-disulfophenyl)-2H-tetrazolium, monosodium salt)) and can range from about 150 to about 300 U/mL of initial blood. Further, the catalase activity can be measured using a catalase activity assay and can be about 125 U/mL.

It should be understood that the process described above is one manner for extracting non-purified antioxidative enzymes from animal blood, although it is possible to simplify the process even further, such as by eliminating organic solvents from the process. For example, in some instances, live poultry can be processed at a poultry/turkey plant by sending the poultry/turkey through the camera in a controlled CO₂ atmosphere. Such treatment protects the poultry blood from clotting, which allows for the removal of EDTA (an anti-clotting agent) from the procedure described above. Further, distilled water can be used to lyse the RBCS instead of Triton X, and the chloroform used in Tsuchihashi treatment can be replaced with an alternative solvent.

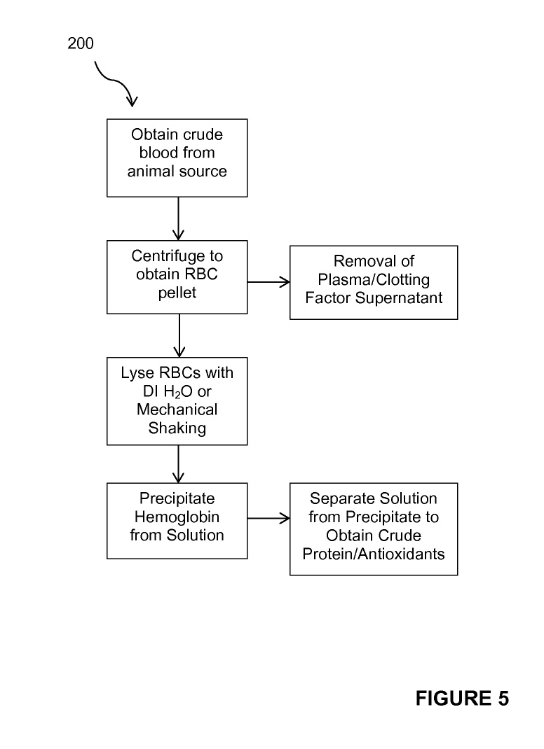

In another embodiment, the crude protein extraction method of the present disclosure can be simplified to avoid the use of such organic solvents as acetone and chloroform, which can be toxic. Such a method can also provide cost savings and can result in the simultaneous extraction of several biomolecules that are involved in antioxidant pathways, including, but not limited to, superoxide dismutase (SOD), catalase, glutathione, glutathione reductase, and glutathione peroxidase. The crude protein composition containing these biomolecules can extracted first by obtaining blood from an animal source, as shown in method 200 of FIG. 5. The blood can be acquired, for example, at a meat or poultry processing plant or at slaughterhouse, after delivery/transportation, or at any other time point during which the animal source is being processed at a rendering facility.

Then, as further shown in the method 200 of FIG. 5, after the blood is obtained, it can be processed, such as by centrifugation, to separate the erythrocytes/red blood cells from the other blood components, such as plasma and clotting factors. After removal of the supernatant, deionized water can be added to the RBCS to facilitate cell lysis. These separation and lysis steps can be skipped, for example if erythrocytes were mechanically lysed during processing (e.g., during transportation or pumping). In the alternative or in conjunction with the addition of deionized water, mechanical shaking or ultrasonication can be utilized to lyse the RBCS. Further, although cell lysis is shown in FIG. 5 as being carried out after separation of the RBCS from whole animal blood, it is to be understood that lysis can also be performed in the whole blood without first separating the RBCS from the other blood components. Regardless of whether the lysis is carried out on whole blood or RBCS only, after cell lysis is complete, a compound or a mixture of two or more compounds can be added to the lysed RBCS to precipitate hemoglobin and facilitate its removal from the lysed RBCS. The hemoglobin precipitation compound can be an inorganic compound such as any suitable metal salt. In one embodiment, the metal salt can be a zinc salt. The zinc salt can be zinc chloride, zinc sulfate, zinc acetate, etc. In other embodiments, an organic solvent such as ethanol, 1-butanol, 2-butanol, isobutanol, tert-butanol, or a combination thereof can be utilized to separate the hemoglobin from the lysed RBCS. Other chemical (change of pH, ionic force etc.) or physical (change of temperature, density separation etc.) means can also be utilized to precipitate the hemoglobin. Further, it is also to be understood that any suitable physical means can be utilized to remove the hemoglobin, such as filtering through a size-separation membrane or electromagnetic fields, ultrafiltration, or electrophoresis. In any event, the resulting solution of lysed RBCS contains the crude protein that includes biomolecules having antioxidant activity, such as superoxide dismutase (SOD), catalase, glutathione, glutathione reductase, and glutathione peroxidase. If desired, when the hemoglobin precipitation compound is an inorganic compound such as a metal salt, such compound can be removed from the solution and the crude protein can be collected in a powder form via the addition of, for instance, a concentrated solution of ammonium sulfate or ammonium nitrate.

For example, about 1 liter of animal blood can be centrifuged at about 1000 g to about 10,000 g for a time period ranging from about 1 minute to about 30 minutes to obtain packed RBCS, which could later be disrupted chemically by mixing with lysing agent solution (e.g. DI water or surfactant) or lysed mechanically by vigorous shaking or application of pressure. Then, a hemoglobin precipitation compound can be added to the cell lysate. The hemoglobin precipitation compound can be an organic solvent such as ethanol, 1-butanol, 2-butanol, isobutanol, (2-methyl-1-propanol), tert-butanol (2-methyl-2-propanol), or other similar solvents leading to precipitation of hemoglobin, as known by those skilled in the art. The solvent can be added to the blood at a concentration ranging from about 1% w/v to about 50% w/v based on the volume of the supernatant solution. For instance, the solvent can be added at a concentration ranging from about 2.5% w/v to about 25% w/v, such as from about 5% w/v to about 20% w/v, such as from about 7.5% w/v to about 15% w/v, based on the volume of the solution. In one embodiment, the organic solvent can be 1-butanol, which can be added at a concentration of about 7% w/v. In still another embodiment, the organic solvent can be tert-butanol, which can be added at a concentration of about 9% w/v. In yet another embodiment, two compounds can be added, where the first compound can be ethanol and the second compound can be 1-butanol, 2-butanol, or isobutanol (2-methyl-1-propanol). In such an embodiment, the first compound can be added at a concentration ranging from about 5% w/v to about 50% w/v, while the second compound can be added at a concentration ranging from about 0.5% w/v to about 30% w/v based on the volume of the solution.

In another embodiment, the hemoglobin precipitation compound can be an inorganic compound, such as a zinc salt or other suitable metal salt. When the hemoglobin precipitation compound is a zinc or other metal salt, it can be applied at a concentration of about 0.1% w/v to about 20% w/v, such as from about 0.5% w/v to about 15% w/v, such as from about 1% w/v to about 10% w/v, based on the volume of the supernatant. After the hemoglobin precipitation compound is added, the resulting solution can be incubated for about 15 minutes or longer, with occasional shaking. The hemoglobin can be precipitated and then removed by decantation or centrifugation at about 1000 g to about 5000 g for a time period of about 1 minute to about 15 minutes. It is also to be understood that analogous procedures can be executed in a flow-through system.

After extraction of the crude protein antioxidants into a solution or powder form, the solution or powder can be applied to a pet food product, an animal feed product, or food product for human consumption to prevent oxidation. For instance, when in the form of a solution, the antioxidants extracted from blood can be applied to the product at a concentration of from about 0.1 microliters of antioxidant solution per gram of product to about 100 microliters of antioxidant solution per gram of product, such as from about 2.5 microliters of antioxidant solution per gram of product to about 90 microliters of antioxidant solution per gram of product, such as from about 5 microliters of antioxidant solution per gram of product to about 75 microliters of antioxidant solution per gram of product. In one embodiment, the product can be applied at a concentration of from about 6.25 microliters of antioxidant solution per gram to about 50 microliters of antioxidant solution per gram of product.

Further, it is to be understood that the crude protein antioxidant solution itself can be concentrated after it is extracted from the blood. For instance, in some embodiments, the antioxidant solution can be from about a 1.5× to about a 10× concentrated solution, such as from about a 2× to about a 8× concentrated solution, such as from about a 3× to about a 6× concentrated solution. In one embodiment, for instance, the antioxidant solution applied to a product can be a 5× concentrated solution.

The antioxidant extraction methods and the resulting non-purified antioxidants that can be used (i.e., antioxidant that has not been purified using chromatography or gel filtration), for instance, as a food or feed preservative, as disclosed herein, may be better understood with reference to the following examples.

### Example 1

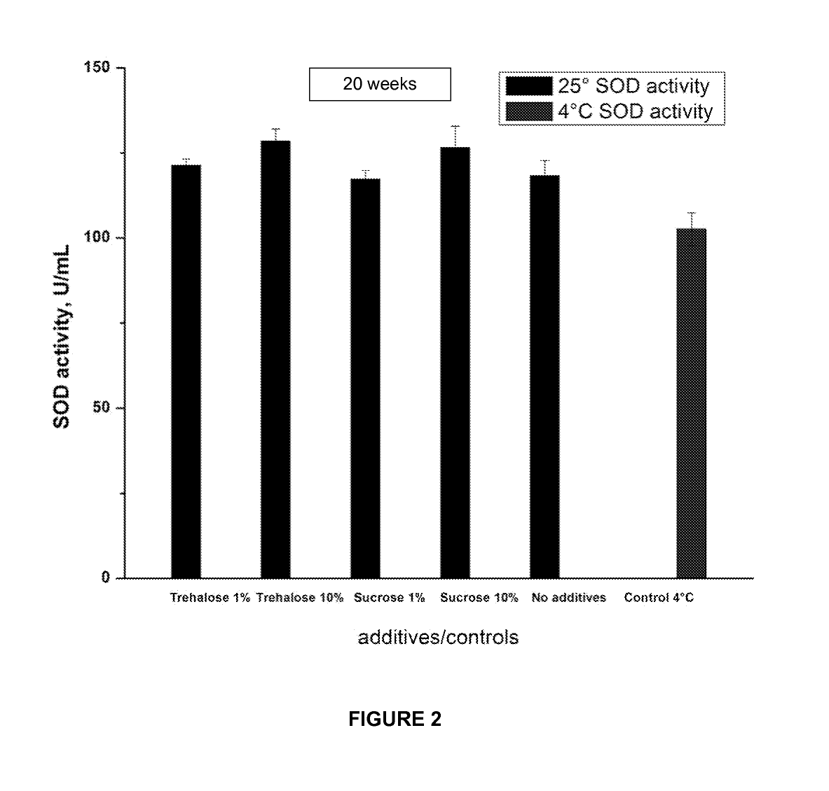

Referring to FIG. 2, the activity in U/mL of SOD extracted by the method of FIG. 1 that was stored in various solutions for 20 weeks at a temperature of 25° C., compared to a control sample stored at 4° C., was determined in the following manner. In order to determine the antioxidant activity of the non-purified SOD in units per milliliter (U/mL) the SOD assay with water-soluble tetrazolium salt, WST-1 (2-(4-lodophenyl)-3-(4-nitrophenyl)-5-(2,4-disulfophenyl)-2H-tetrazolium, monosodium salt) can be used. In this assay, WST-1 produces a water-soluble formazan dye upon reduction with the superoxide anion. The rate of the reduction of WST-1 with O₂— is linearly related to the xanthine oxidase (XO) activity, and this reduction is inhibited by SOD.

As a control, the activity of a sample of SOD in solution and kept at 4° C. was determined to be about 100 U/mL. Meanwhile, the activity of a sample of SOD stored in a 1% trehalose solution was from about 100 U/mL to about 125 U/mL, the activity of a sample of SOD stored in a 10% trehalose solution was from about 125 U/mL to about 150 U/mL, the activity of a sample of SOD stored in a 10% sucrose solution was from about 100 U/mL to about 125 U/mL, and the activity of a sample of SOD stored in a 1% sucrose solution was from about 0 U/mL to about 10 U/mL. The activity of a sample of SOD stored in a solution without additives was from about 100 U/mL to about 125 U/mL.

### Example 2

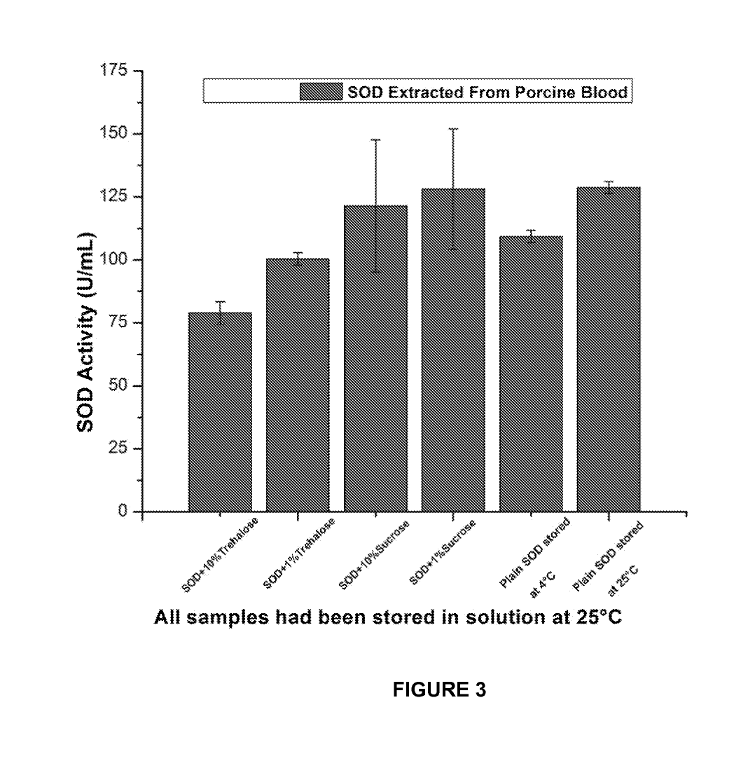

Next, as shown in FIG. 3, the activity in U/mL of SOD stored in various solutions for 40 weeks at a temperature of 25° C., compared to a control sample stored at 4° C., was determined in the same manner as described in Example 1 above. As a control, the activity of a sample of SOD in solution and kept at 4° C. was determined to be about 100 U/mL. Meanwhile, the activity of a sample of SOD stored in a 1% trehalose solution was from about 90 U/mL to about 105 U/mL, the activity of a sample of SOD stored in a 10% trehalose solution was from about 70 U/mL to about 80 U/mL, the activity of a sample of SOD stored in a 10% sucrose solution was from about 90 U/mL to about 150 U/mL, and the activity of a sample of SOD stored in a 1% sucrose solution was from about 100 U/mL to about 150 U/mL. The activity of a sample of SOD stored in a solution without additives was about 100 125 U/mL. Examples 1 and 2 show that SOD extracts obtained using the method shown in FIG. 1 and stored without any stabilizers remain stable and active for at least 40 weeks if stored at room temperature.

### Example 3

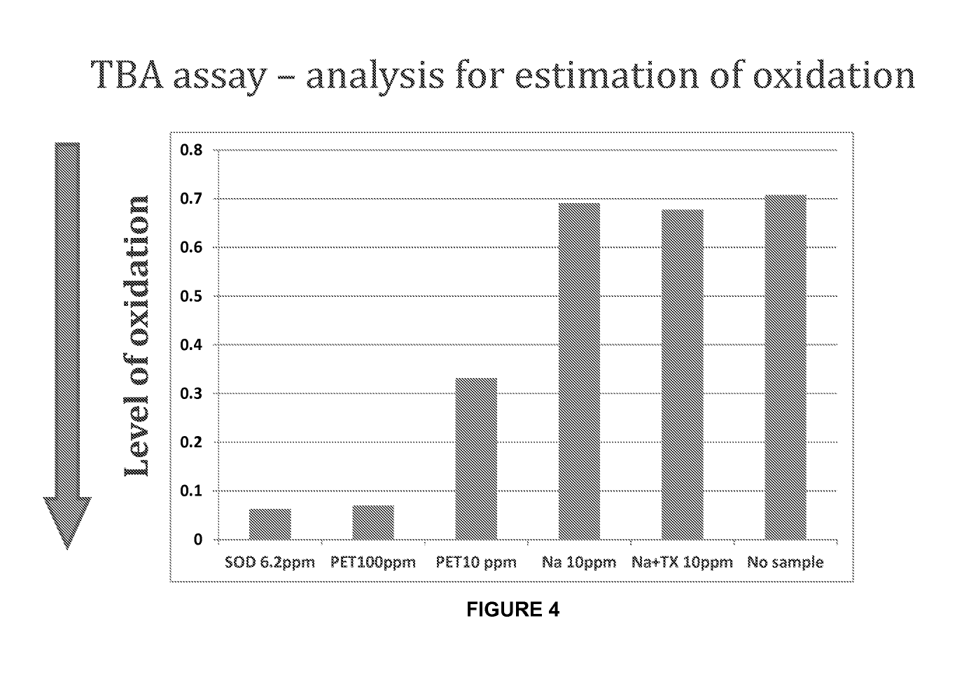

Further, as shown in FIG. 4, antioxidant efficiency of SOD extracts was determined in a model food system. In this particular assay, a model lipid-safflower oil has been used. Oxidation levels for safflower oil samples treated with SOD were determined using a thiobarbituric acid (TBA) assay and compared to those in safflower oil samples treated by three commercially available antioxidants currently used in feed preservatives—PET-OX™ (Pet), NATUROX™ (Na), and NATUROX PLUS™ (Na-TX). PET-OX™ is a synthetic antioxidant currently used in animal feed that contains butylated hydroxyanisole and butylated hydroxytoluene. It is generally used in animal feed at a concentration of from about 150 parts per million (ppm) to about 500 ppm. Meanwhile, NATUROX™ and NATUROX PLUS™ are natural antioxidants that contain mixed tocopherols. After treating animal feed samples with various concentrations of the three types of antioxidants, the thiobarbituric acid (TBA) assay was performed, and the level of TBA present was measured as absorbance at 532 nm corresponding to the level of lipid oxidation. Hence, a sample having a lower absorbance corresponded with a lower amount of oxidation of the food sample.

First, a control sample that was not treated with an antioxidant had an absorbance of 0.7 to about 0.8. A sample treated with 10 ppm of NATUROX™ and a sample treated with 10 ppm of NATUROX PLUS™ both had an absorbance of about 0.6 to about 0.7. Meanwhile, a sample treated with 10 ppm of PET-OX™ had an absorbance of from about 0.3 to about 0.4. By increasing the concentration of the PET-OX™ to 100 ppm, the absorbance was reduced to a level of from about 0.05 to about 0.1, indicating a lower level of oxidation. When a sample was treated with 6.2 ppm of SOD extract, the sample had an absorbance of from about 0.05 to about 0.1. Thus, a sample treated with only 6.2 ppm of SOD exhibits a similar amount of oxidation as a sample treated with 100 ppm of the PET-OX™ antioxidant.

Thus, even though the SOD antioxidant of the present disclosure is not purified via chromatography or gel filtration methods, the graph of FIG. 4 demonstrates that process described herein still yields a potent antioxidant that can prevent oxidation of, for instance, fats and oils in animal feed. However, it is to be understood that the non-purified SOD product described herein, as well as the method of extracting the non-purified SOD product, may also be used on other products besides foods or animal feeds, such as paint, caulking, plastics, or any other products that are at risk for oxidation.

### Example 4

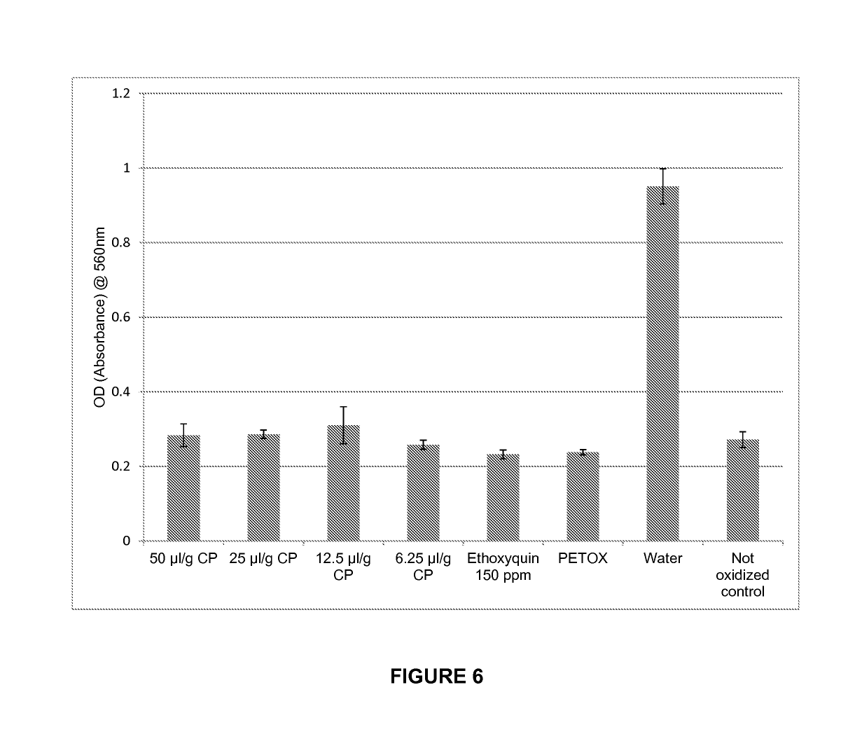

Example 4 refers to FIG. 6, which compares the ability of the natural antioxidants in the crude protein of the present disclosure with the ability of currently used feed preservative antioxidants to prevent oxidation in ground chicken patties. The crude protein was obtained by the method of FIG. 5 where zinc chloride was used to separate the hemoglobin in the RBCS from the crude protein solution, which contains the antioxidants. The crude protein was then applied to a first sample of chicken meat at a concentration of 50 microliters per gram, a second sample of chicken meat at a concentration of 25 microliters per gram, a third sample of chicken meat at a concentration of 12.5 microliters per gram, and a fourth sample of chicken meat at a concentration of 6.25 microliters per gram. The zinc concentration in all crude protein samples was 250 ppm. For comparison, ethoxyquin was applied to a fifth sample of chicken meat at a concentration of 150 parts per million (ppm) based on total weight, PET-OX™ was applied to a sixth of chicken meat at a concentration of 1000 ppm based on fat content, and water was applied to a seventh sample of chicken meat as a control. These seven samples were subjected to oxidation at 50° C. for 12 hours. An eighth sample having no treatment was left as the non-oxidized control and was stored in a refrigerator at 4° C.

After 12 hours, a ferrous oxidation-xylenol (FOX) assay was run on the samples to determine the absorbance (optical density) of the remaining solution at 560 nanometers, where a lower absorbance reading corresponds with a lower level of oxidation. As shown, the crude protein solutions of the present disclosure had an absorbance of less than about 0.3, which was similar to the readings of currently available antioxidants (ethoxyquin and PET-OX™), which are not as safe and are more expensive. The absorbance of the four crude protein samples was also similar to the absorbance of the sample that was not subjected to oxidation, which indicates that the crude protein solutions extracted by the method of the present disclosure and applied to chicken meat at concentrations ranging from about 6.25 microliters per gram to about 50 microliters per gram are effective at preventing oxidation of the chicken meat.

### Example 5

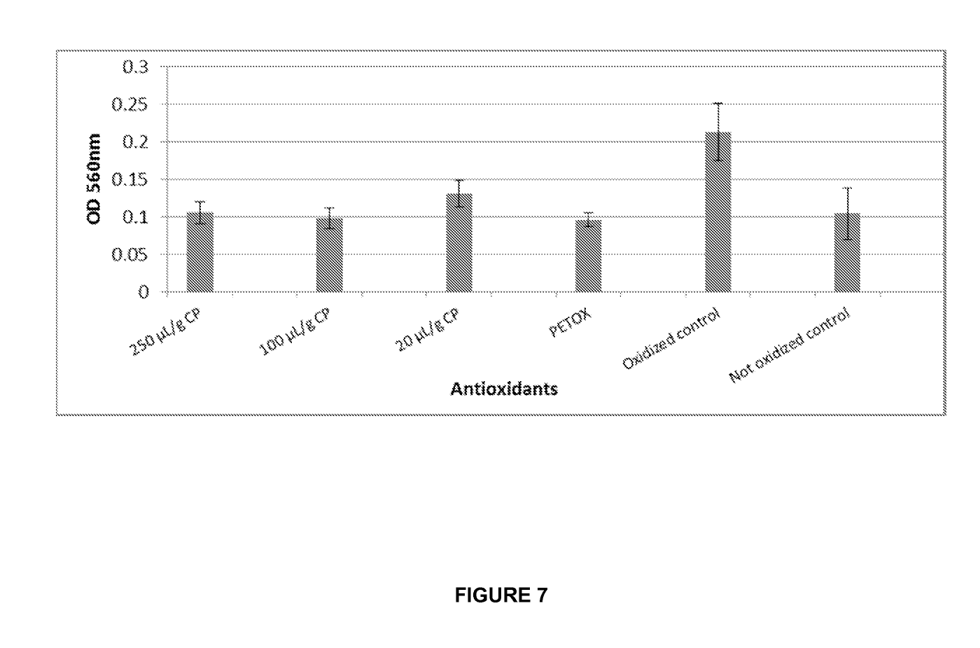

Example 5 is summarized by FIG. 7, which is a graph comparing the ability of the natural antioxidants in the crude protein of the present disclosure with the ability of currently used feed preservative antioxidants to prevent oxidation in liquid chicken fat. Crude protein was extracted according to the method described in FIG. 5, the resulting solution containing natural antioxidant biomolecules. The crude protein solution was mixed with liquid chicken fat so that the crude protein was present in a first sample at a concentration of 250 microliters per gram of fat, in a second sample at a concentration of 100 microliters per gram of fat, and in a third sample at a concentration of 20 microliters per gram of fat. For comparison, PET-OX™ was applied to a fourth sample of chicken fat at a concentration of 500 ppm. A fifth sample of chicken fat was not treated with an antioxidant (e.g., oxidized control). These five samples were subjected to oxidation at 50° C. for 12 hours. An sixth sample having no treatment was left as the non-oxidized control and was stored in a refrigerator at 4° C.

After 12 hours, a ferrous oxidation-xylenol (FOX) assay was run on the samples to determine the absorbance (optical density) of the remaining solution at 560 nanometers, where a lower absorbance reading corresponds with a lower level of oxidation. As shown, the crude protein solutions of the present disclosure had an absorbance of less than about 0.125, which was similar to the reading for PET-OX™), which is not as safe and is more expensive. The absorbance of the three crude protein samples was also similar to the absorbance of the sample that was not subjected to oxidation and much less than the untreated sample that was subjected to oxidation, which indicates that the crude protein solutions extracted by the method of the present disclosure and applied to chicken meat at concentrations ranging from about 20 microliters per gram to about 250 microliters per gram are effective at preventing oxidation of liquid chicken fat.

### Example 6

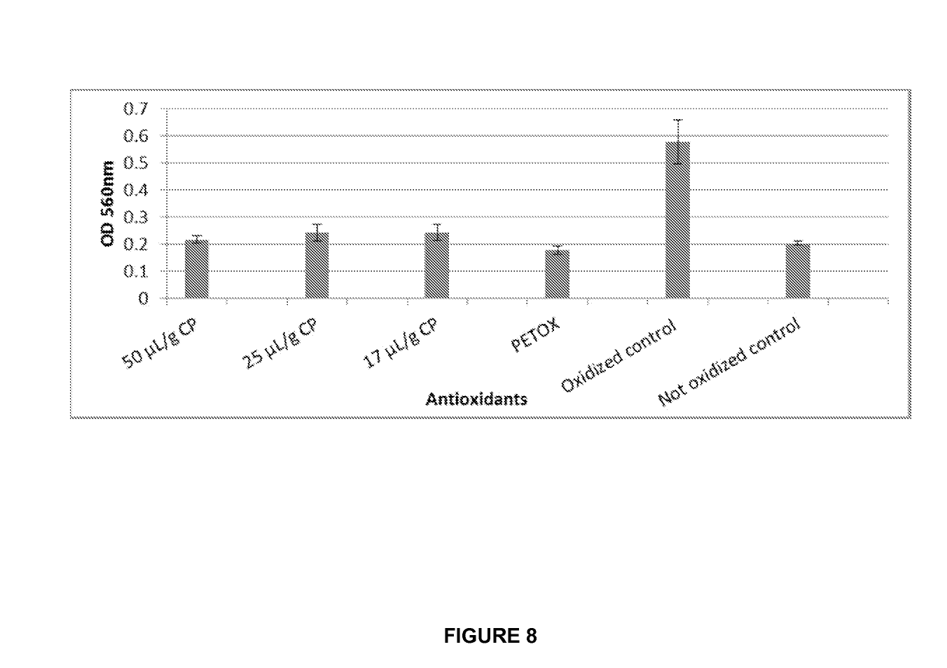

Example 6 refers to FIG. 8, which compares the ability of the natural antioxidants in the crude protein of the present disclosure with the ability of currently used feed preservative antioxidants to prevent oxidation in ground chicken patties. Crude protein was extracted according to the method described in FIG. 5, the resulting solution containing natural antioxidant biomolecules. The crude protein solution was mixed with ground chicken patties so that the crude protein was present in a first sample at a concentration of 50 microliters per gram of ground meat, in a second sample at a concentration of 25 microliters per gram of ground chicken patties, and in a third sample at a concentration of 17 microliters per gram of ground chicken patties. For comparison, PET-OX™ was applied to a fourth sample of ground chicken patties at a concentration of 500 ppm. A fifth sample of ground chicken patties was not treated with an antioxidant (e.g., oxidized control). These five samples were subjected to oxidation at 50° C. for 12 hours. An sixth sample having no treatment was left as the non-oxidized control and was stored in a refrigerator at 4° C.

After 12 hours, a ferrous oxidation-xylenol (FOX) assay was run on the samples to determine the absorbance (optical density) of the remaining solution at 560 nanometers, where a lower absorbance reading corresponds with a lower level of oxidation. As shown, the crude protein solutions of the present disclosure had an absorbance of less than about 0.2, which was similar to the reading for PET-OX™), which is not as safe and is more expensive. The absorbance of the three crude protein samples was also similar to the absorbance of the sample that was not subjected to oxidation and much less than the untreated sample that was subjected to oxidation, which indicates that the crude protein solutions extracted by the method of the present disclosure and applied to ground chicken patties at concentrations ranging from about 17 microliters per gram to about 50 microliters per gram are effective at preventing oxidation of ground chicken patties.

### Example 7

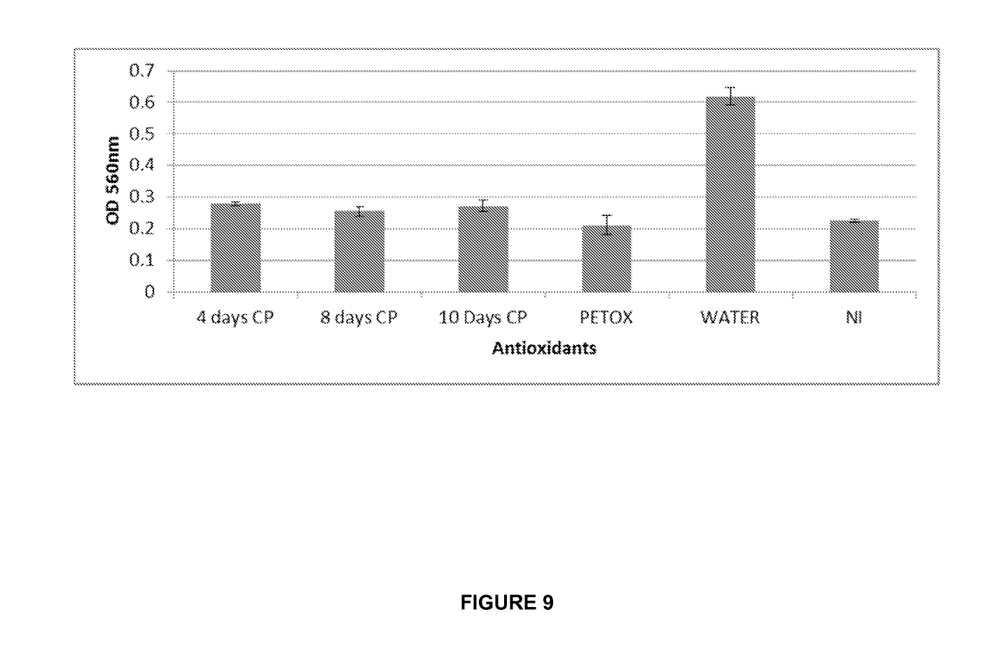

Example 7, which refers to FIG. 9, shows the ability of the natural antioxidants in the crude protein of the present disclosure to remain effective after accelerated aging for up to 10 days at 50° C., which is the equivalent of 3-4 months at a room temperature of about 25° C. and more than 1 year at a refrigerated temperature of about 4° C. Crude protein samples were aged for 4 days, 8 days, and 10 days, and incubated with ground chicken meat; the samples were subjected to oxidation at 50° C. for 12 hours. Oxidation levels were assessed using FOX assay; each sample treated by crude protein had an absorbance of less than 0.3 when determined at a wavelength of 560 nanometers. This was similar to the absorbance of a sample incubated with PET-OX™ (1000 ppm based on fat content), which not subjected to the accelerated aging that the crude protein antioxidant solutions underwent.

The results of Example 7 show that the crude protein extracted by the method of the present disclosure can have a long shelf life of at least about 3-4 months at room temperature, which is notable given that many proteins and enzymes are fragile and have a limited shelf life.

### Example 8

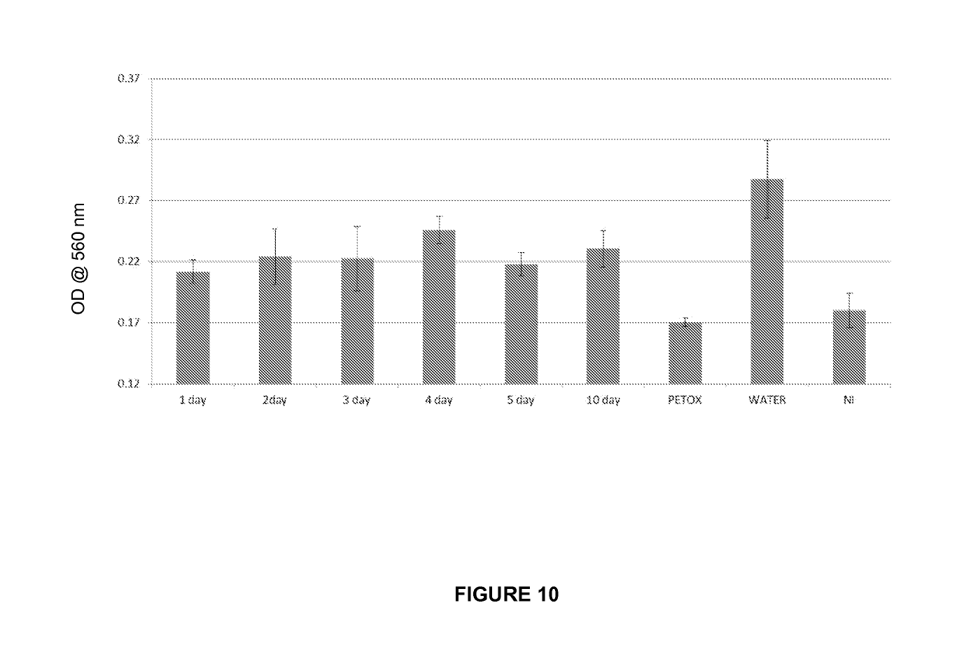

Example 8, which refers to FIG. 10, demonstrates the ability of the natural antioxidants in the crude protein of the present disclosure to remain effective after accelerated aging at 50° C. for up to 10 days when used to treat chicken fat. Similar to Example 7, the sample treated with PET-OX^{Tm} was not incubated at 50° C. Meanwhile, the crude protein solution of the present disclosure was aged for 1 day, 2 days, 3 days, 4 days, 5 days, and 10 days, after which time 25 microliters of the crude protein was mixed with 475 microliters of chicken fat. Then, the mixture was incubated for 12 hours at 50° C., and a FOX assay performed where the absorbance of each of the solutions at 560 nanometers was determined.

As shown, even after 10 days of accelerated aging, the crude protein solutions of the present disclosure exhibited an absorbance of less than 0.25, which demonstrates that the crude protein was able to prevent oxidation in the chicken fat, and its efficiency was not degrading during accelerated aging.

### Example 9

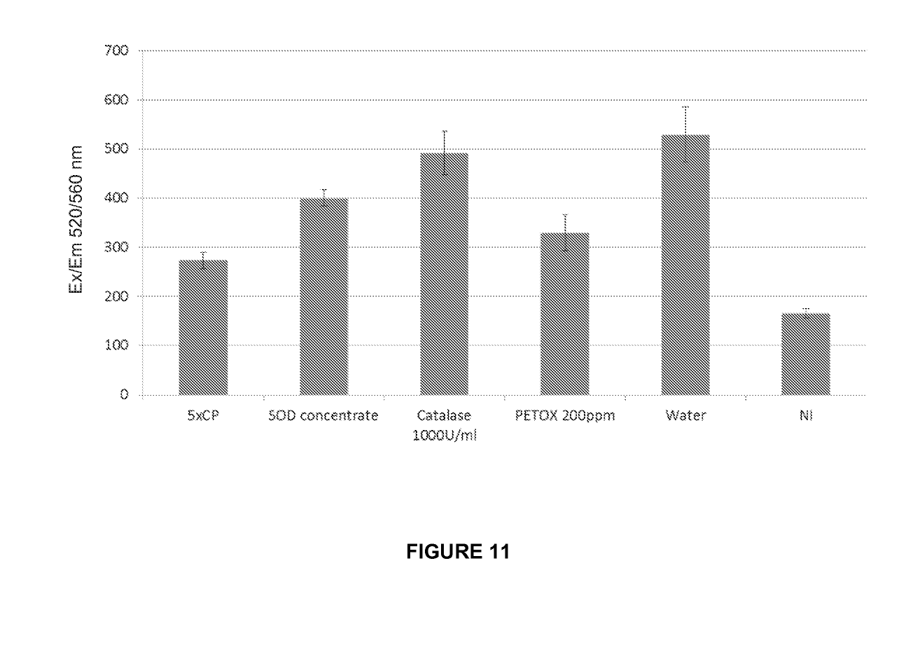

Example 9, which refers to FIG. 11, compares the antioxidant activity of a crude protein solution, SOD concentrate, 1000 U/mL catalase, PET-OX™, and water when applied to beef patties using a TBARS assay. The crude protein was obtained using the method of FIG. 5, where 1 millimeter was obtained from 5 milliliters of blood, where the zinc concentration was around 4800 ppm. (However, note that after adding the solution to the beef patty sample, the final zinc content was reduced to around 240 ppm). Then, the crude protein was concentrated 5 times using filtration through a membrane with a molecular weight cutoff of 3,000 Da to yield a 5× concentrate. The SOD was obtained using the method of FIG. 1, where hemoglobin was precipitated by an ethanol-chloroform mixture. For the assay, 1.5 grams of ground beef was mixed with 75 microliters of antioxidants and incubated for 12 hours at 37° C., so that the concentration of antioxidants per gram of meat was 50 microliters per gram. After treating the beef patties with the various antioxidants, water, or a non-incubated control, the TBA assay was performed as described above in Example 4; however TBA content was measured using fluorescence with the excitation wavelength of 520 nm and emission wavelength of 560 nm. The level of TBA present in the sample corresponded to the level of oxidation present based on the fluorescence reading. Hence, a lower fluorescence reading corresponded to a lower of amount of TBA in the sample, which corresponded with a lower amount of oxidation of the animal feed.

As shown, the 5× concentrate of crude protein of the present disclosure showed the lowest amount of oxidation, followed by 1000 ppm of PET-OX™, then the SOD concentrate, then the 1000 U/mL catalase.

### Example 10

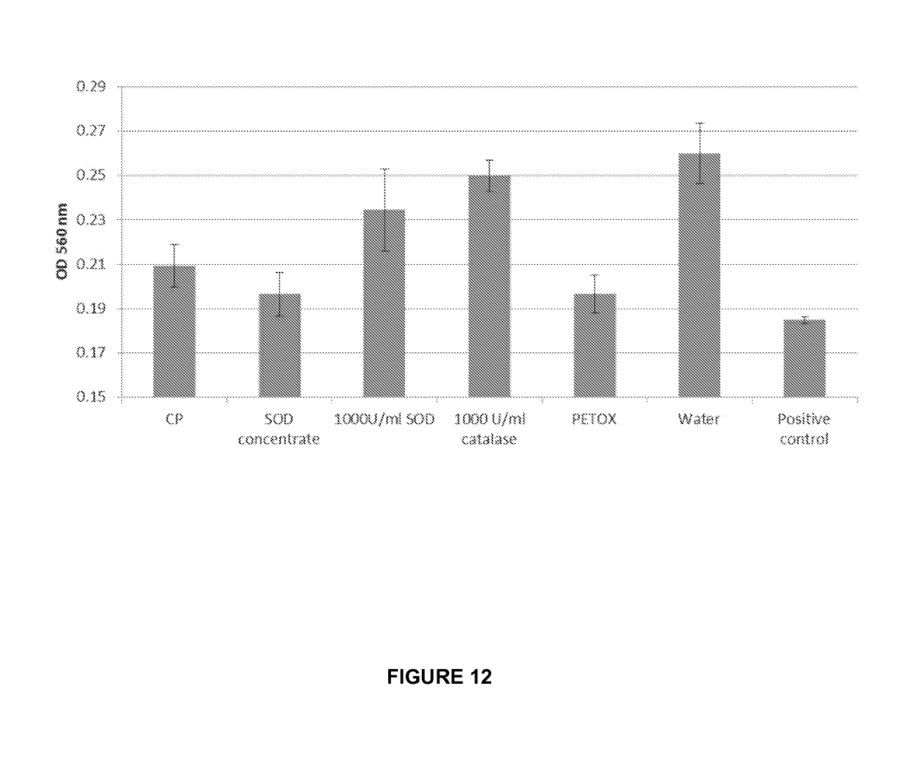

Example 10, which refers to FIG. 12, compares the antioxidant activity of a crude protein solution obtained using the method of FIG. 5, SOD concentrate obtained using the method of FIG. 1, 1000 U/mL SOD, 1000 U/mL catalase, PET-OX™, and water when applied to chicken fat. Water was used as the negative control while a sample stored at 4° C. was the positive control. The levels of oxidation were measured using a FOX assay.

As shown, the crude protein, SOD concentrate, and PET-OX™ had absorbances of less than 0.21 at 560 nanometers and were thus must effective at preventing oxidation. The chicken fat treated with water only exhibited the highest level of oxidation, while the 1000 U/mL of commercial bovine SOD and the 1000 U/mL catalase prevented oxidation to a lesser extent than the crude protein, SOD concentrate, and PET-OX™. The Crude protein, SOD concentrate and PET-OX™ inhibited about 85% of the oxidation, while the 1000 U/mL SOD decreased the oxidation by about 34% and the 1000 U/mL catalase decreased the oxidation by about 13%.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

What is claimed is:

1. An antioxidant for preserving a food product, wherein the antioxidant is extracted from animal tissue.

2. The antioxidant of claim 1, wherein the animal tissue is animal blood.

3. The antioxidant of claim 2, wherein the animal blood is avian, bovine, or porcine blood.

4. The antioxidant of claim 1, wherein the antioxidant comprises superoxide dismutase (SOD), catalase, glutathione, glutathione reductase, glutathione peroxidase, or a combination thereof.

5. The antioxidant of claim 1, wherein the antioxidant is generally free from hemoglobin.

6. A method of extracting an antioxidant from animal blood, the method comprising:
obtaining a sample of animal blood, wherein the animal blood contains erythrocytes;
lysing the erythrocytes to form a solution containing the antioxidant; and
removing hemoglobin from the solution, wherein the hemoglobin is removed by treating the solution with at least one compound or by a physical method, wherein the physical method comprises ultrafiltration or electrophoresis.

7. The method of claim 6, wherein the compound is an inorganic compound.

8. The method of claim 7, wherein the inorganic compound is a metal salt.

9. The method of claim 7, wherein the inorganic compound is a zinc salt or other zinc-containing compound.

10. The method of claim 7, wherein the inorganic compound is added at a concentration ranging from 0.1% w/v to about 20% w/v based on the volume of the solution.

11. The method of claim 6, wherein the compound is tert-butanol (2-methyl-2-propanol).

12. The method of claim 11, wherein the tert-butanol (2-methyl-2-propanol) is added at a concentration ranging from about 1% w/v to about 50% w/v based on the volume of the solution.

13. The method of claim 6, wherein the solution is treated with a first compound that is ethanol and a second compound that is 1-butanol, 2-butanol, or isobutanol (2-methyl-1-propanol).

14. The method of claim 13, wherein the first compound is added at a concentration ranging from about 5% w/v and 50% w/v and the second compound is added at a concentration ranging from about 0.5% w/v to about 30% w/v based on the volume of the solution.

15. A method of treating a food product with an antioxidant, the method comprising:
extracting an antioxidant from erythrocytes in animal blood; and
applying the antioxidant to the food product.

16. The method of claim 15, wherein extracting the antioxidant from animal blood comprises:
obtaining animal blood, wherein the animal blood contains erythrocytes;
lysing the erythrocytes to form a solution containing the antioxidant; and
removing hemoglobin from the solution, wherein the hemoglobin is removed by treating the solution with at least one compound or by a physical method, wherein the physical method comprises ultrafiltration or electrophoresis.

17. The method of claim 16, wherein the compound is an inorganic compound.

18. The method of claim 17, wherein the inorganic compound is a metal salt.

19. The method of claim 17, wherein the inorganic compound is a zinc salt or other zinc containing compound.

20. The method of claim 17, wherein the inorganic compound is added at a concentration ranging from about 0.1% w/v to about 20% w/v based on the volume of the solution.

21. The method of claim 16, wherein the antioxidant is in the form of a solution applied at a concentration ranging from about 0.1 microliters per gram of food product to about 100 microliters per gram of food product.

22. The method of claim 16, wherein antioxidant is in an unpurified state.

23. The method of claim 16, wherein the food product is pet food, animal feed, or food for human consumption.
